(19) United States
(12) Patent Application Publication
(10) Pub. No.: US 2026/0312510 A1
(43) Pub. Date: Oct. 8, 2026

(54) AC-DC CONVERTER, ROTARY MACHINE DRIVER, AND REFRIGERATION CYCLE APPLIED EQUIPMENT

(71) Applicant: MITSUBISHI ELECTRIC CORPORATION, Tokyo (JP)

(72) Inventor: Kengo KAWAUCHI, Tokyo (JP)

(73) Assignee: MITSUBISHI ELECTRIC CORPORATION, Tokyo (JP)

(21) Appl. No.: 19/481,896

(22) PCT Filed: Feb. 21, 2024
(86) PCT No.: PCT/JP2024/006337

§ 371 Date: Nov. 6, 2025

(30) Foreign Application Priority Data
Jun. 12, 2023 (JP) 2023-096269

(51) Int. Cl. H02M 7/217; F24F 11/88

(52) U.S. Cl. CPC H02M 7/217; F24F 11/88

(57) ABSTRACT

An AC-DC converter includes: a rectifier circuitry that rectifies power supply voltage applied from an AC power supply, the rectifier circuitry including a switching element; a capacitor that smooths output voltage of the rectifier circuitry, the capacitor being connected to a DC bus; a reactor disposed closer to the AC power supply than the capacitor; and a controller that generates a switching signal for controlling the switching element. The controller generates the switching signal such that a harmonic component included in power supply current conforms to a harmonic standard value of the power supply current, the power supply current flowing between the AC power supply and the rectifier circuitry.

### FIELD

The present disclosure relates to: an AC-DC converter that converts AC power into desired DC power; and a rotary machine driver and a refrigeration cycle applied equipment that include the AC-DC converter.

### BACKGROUND

When DC voltage is obtained from an AC power supply, a power factor correction circuit is generally used. The power factor correction circuit has a function of controlling bus voltage in such a way as to keep the bus voltage at a constant level and a function of controlling power supply current such that the power supply current can conform to the harmonic standard. A power factor correction circuit and a “simple switching method” (also referred to as a “partial switching method”), which is a type of control method for the power factor correction circuit, are based on a method in which switching is performed at least once in a half cycle of power supply voltage that is the voltage of an AC power supply, and are characterized in that bus voltage can be controlled such that the bus voltage is lower than a peak value of the power supply voltage. However, when the bus voltage is set to a value lower than the peak value of the AC power supply by the simple switching method, an operation circuit is switched from a boost chopper to a capacitor input type diode rectifier, leading to distortion of power supply current. This is a problem with the simple switching method.

In order to address this problem, the conventional technique disclosed in Patent Literature 1 below achieves a desired control regarding whether a combination of reactor capacity and switching timing can conform to the harmonic standard, by repeating design for each load power.

### CITATION LIST

### Patent Literature

Patent Literature 1: Japanese Patent Application Laid-open No. 2000-125545

### SUMMARY OF INVENTION

### Problem to be Solved by the Invention

However, since the conventional technique described in Patent Literature 1 is a method in which conformity with the harmonic standard is checked by repeated trials, the technique has a problem in that the number of trials increases exponentially as the number of pulses increases. In addition, the conventional technique described in Patent Literature 1 also has a problem in that since guidelines for quantitatively and uniquely designing control gain are not clear, it takes a lot of time to complete control gain design.

The present disclosure has been made in view of the above, and an object of the present disclosure is to shorten a time required for design by obtaining an AC-DC converter that achieves conformity with the harmonic standard without relying on trial-and-error adjustment.

### Means to Solve the Problem

In order to solve the above-described problems and achieve the object, an AC-DC converter according to the present disclosure includes: a rectifier circuitry; a smooth capacitor; a reactor; and a controller. The rectifier circuitry includes at least one switching element, and rectifies power supply voltage applied from an AC power supply. The capacitor is connected to a DC bus, and smooths output voltage of the rectifier circuitry. The reactor is disposed closer to the AC power supply than the capacitor. When generating a switching signal for controlling the switching element disposed closer to the AC power supply than the capacitor, the controller generates the switching signal such that a harmonic component included in power supply current conforms to a harmonic standard value of the power supply current, the power supply current flowing between the AC power supply and the rectifier circuitry.

### Effects of the Invention

The AC-DC converter according to the present disclosure achieves conformity with the harmonic standard without relying on trial-and-error adjustment. Thus, the AC-DC converter according to the present disclosure has the effect of shortening the time required for designing.

### BRIEF DESCRIPTION OF DRAWINGS

FIG. 1 is a block diagram illustrating an exemplary configuration of a rotary machine driver according to a first embodiment.

FIG. 2 is a circuit diagram illustrating an exemplary configuration of an AC-DC converter according to the first embodiment.

FIG. 3 is a block diagram illustrating an exemplary configuration of a controller according to the first embodiment.

FIG. 4 is a block diagram illustrating an exemplary configuration of a voltage controller according to the first embodiment.

FIG. 5 is a block diagram illustrating an exemplary configuration of a current controller according to the first embodiment.

FIG. 6 is a block diagram illustrating an exemplary configuration of the current controller obtained by introduction of a target value filter into the current controller illustrated in FIG. 5.

FIG. 7 is a block diagram for describing a transfer function of a current control system in the AC-DC converter including the current controller illustrated in FIG. 6.

FIG. 8 is a diagram illustrating exemplary operation waveforms of power supply voltage, bus voltage, and power supply current to be obtained when PI control is applied to the current control device illustrated in FIG. 6.

FIG. 9 is a diagram illustrating exemplary operation waveforms of power supply voltage, bus voltage, and power supply current to be obtained when PS control is applied to the current control device illustrated in FIG. 6.

FIG. 10 is a diagram illustrating exemplary current harmonic characteristics to be exhibited when the PS control is applied to the current control device illustrated in FIG. 6.

FIG. 11 is a diagram illustrating an exemplary relationship between a harmonic-component sum ratio and operating power to be exhibited when the PS control is applied to the current control device illustrated in FIG. 6.

FIG. 12 is a diagram illustrating an exemplary configuration of an AC-DC converter according to a second embodiment.

FIG. 13 is a diagram illustrating an exemplary configuration of an AC-DC converter according to a third embodiment.

FIG. 14 is a diagram illustrating an exemplary configuration of an AC-DC converter according to a fourth embodiment.

FIG. 15 is a diagram illustrating an exemplary configuration of an AC-DC converter according to a fifth embodiment.

FIG. 16 is a diagram illustrating an exemplary configuration of an AC-DC converter according to a sixth embodiment.

FIG. 17 is a diagram illustrating an exemplary configuration of an AC-DC converter according to a seventh embodiment.

FIG. 18 is a diagram illustrating an exemplary configuration of an AC-DC converter according to an eighth embodiment.

FIG. 19 is a diagram illustrating an exemplary configuration of an AC-DC converter according to a ninth embodiment.

FIG. 20 is a diagram illustrating an exemplary configuration of an AC-DC converter according to a tenth embodiment.

FIG. 21 is a diagram illustrating an exemplary configuration of an AC-DC converter according to an eleventh embodiment.

FIG. 22 is a diagram illustrating an exemplary configuration of an AC-DC converter according to a twelfth embodiment.

FIG. 23 is a diagram illustrating an exemplary configuration of an AC-DC converter according to a thirteenth embodiment.

FIG. 24 is a diagram illustrating an exemplary configuration of an AC-DC converter according to a fourteenth embodiment.

FIG. 25 is a diagram illustrating an exemplary configuration of an AC-DC converter according to a fifteenth embodiment.

FIG. 26 is a diagram illustrating an exemplary configuration of a refrigeration cycle applied equipment according to a sixteenth embodiment.

### DESCRIPTION OF EMBODIMENTS

Hereinafter, an AC-DC converter, a rotary machine driver, and a refrigeration cycle applied equipment according to embodiments of the present disclosure will be described in detail with reference to the accompanying drawings.

### First Embodiment

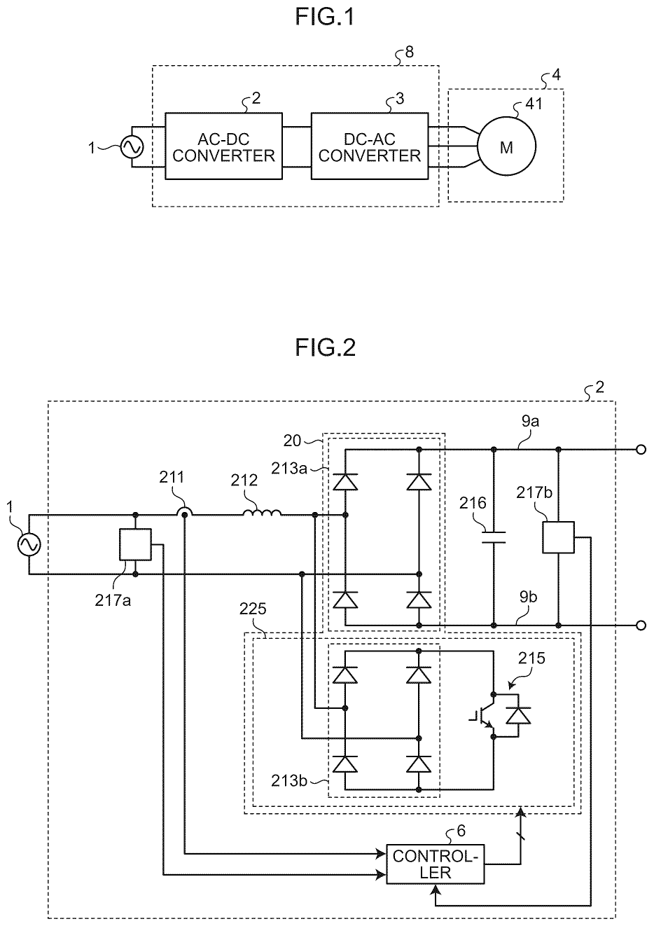

FIG. 1 is a block diagram illustrating an exemplary configuration of a rotary machine driver 8 according to a first embodiment. The rotary machine driver 8 is connected to an AC power supply 1 and a load 4 including a motor 41. The rotary machine driver 8 includes an AC-DC converter 2 and a DC-AC converter 3. When the rotary machine driver 8 is used for an air conditioner, the load 4 is a compressor or a fan, and the motor 41 is a compressor motor or a fan motor.

FIG. 2 is a circuit diagram illustrating an exemplary configuration of the AC-DC converter 2 according to the first embodiment. The AC-DC converter 2 according to the first embodiment includes, as main components, a controller 6, a rectifier circuitry 20, a reactor 212, and a capacitor 216. In addition, the AC-DC converter 2 includes a current detector 211 and voltage detectors 217a and 217b as voltage or current detection means. Note that, herein, when the voltage detectors 217a and 217b are distinguished from each other without reference numerals, the voltage detector 217b is referred to as a “first voltage detector”, and the voltage detector 217a is referred to as a “second voltage detector”.

The rectifier circuitry 20 includes: single-phase diode bridge cells 213a and 213b each including four diodes that are bridge-connected; and a switching element 215 that is connected in parallel to both ends of the single-phase diode bridge cell 213b. The single-phase diode bridge cells 213a and 213b are connected in parallel to each other with respect to the AC power supply 1. The rectifier circuitry 20 as illustrated in FIG. 2 is referred to as a “simple switching circuit”. The single-phase diode bridge cell 213b and the switching element 215 constitute a switching cell 225. The switching element 215 performs switching operation at least once in a half cycle of the power supply voltage.

The capacitor 216 is connected between a DC bus 9a and a DC bus 9b. The reactor 212 is disposed closer to the AC power supply than the capacitor 216. The rectifier circuitry 20 receives power supply voltage applied from the AC power supply 1 via the reactor 212, and rectifies the received power supply voltage. The capacitor 216 smooths output voltage of the rectifier circuitry 20.

The voltage detector 217b detects bus voltage which is voltage of the DC bus to which the capacitor is connected. The voltage detector 217a detects power supply voltage. The current detector 211 detects power supply current flowing between the AC power supply 1 and the rectifier circuitry 20.

Each of detection values of the voltage detectors 217a and 217b, and the current detector 211 is input to the controller 6. The controller 6 generates a switching signal for controlling the turning on and off of the switching element 215 based on f each detection value.

An example of the switching element 215 is the insulated gate bipolar transistor (IGBT) illustrated in the drawing, but is not limited to the IGBT. Any element may be used as the switching element 215 as long as switching operation can be performed. Another example of the switching element 215 is a metal-oxide-semiconductor field-effect transistor (MOSFET).

In addition, although the AC-DC converter 2 illustrated in FIG. 2 is configured as a closed loop in which the respective detection values of the voltage detectors 217a and 217b and the current detector 211 are used, the AC-DC converter 2 may be configured as an open loop in which a target value, an estimated value, and the like are used. In a case where the AC-DC converter 2 is configured as an open loop, it is possible to control the switching element 215 without using the respective detection values of the voltage detectors 217a and 217b and the current detector 211.

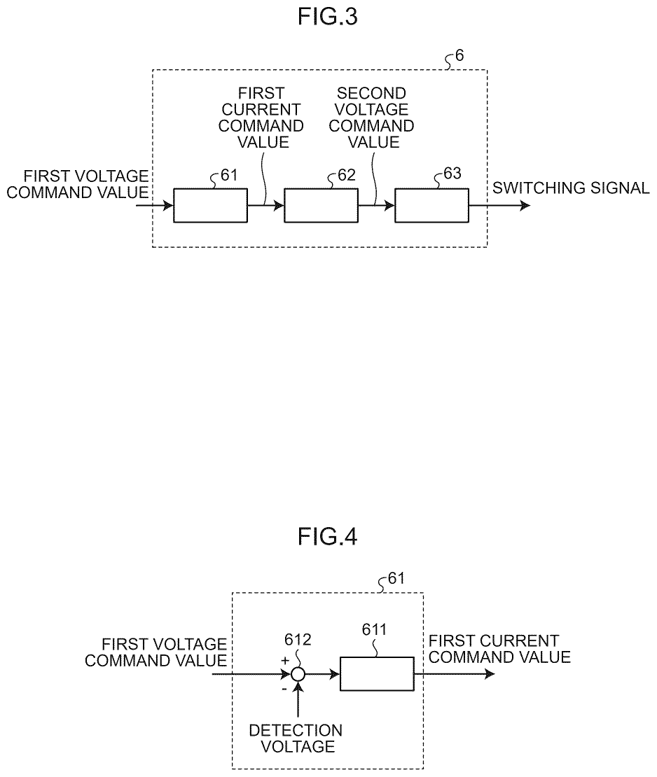

FIG. 3 is a block diagram illustrating an exemplary configuration of the controller 6 according to the first embodiment. The controller 6 includes a voltage controller 61, a current controller 62, and a switching signal generator 63. The voltage controller 61 generates a first current command value by using a first voltage command value. The current controller 62 generates a second voltage command value by using the first current command value. The switching signal generator 63 generates a switching signal by using the second voltage command value.

FIG. 4 is a block diagram illustrating an exemplary configuration of the voltage controller 61 according to the first embodiment. The voltage controller 61 includes a voltage control device 611 and a subtracter 612. The voltage controller 61 generates the first current command value by using the first voltage command value that is a command value of the bus voltage. More specifically, the subtracter 612 generates a voltage deviation that is a difference between the first voltage command value and a detection voltage detected by the voltage detector 217b. The voltage control device 611 generates the first current command value by using the voltage deviation output from the subtracter 612. The voltage control device 611 may be configured by, for example, a proportional integral (PI) controller.

In a case where the voltage control device 611 is configured by a PI controller, a transfer function G_{AVR(s)} can be expressed by formula (1) below.

$$Formula 1$$

$${G}_{AVR ( s )} = {K}_{pAVR} + \frac{{K}_{l AVR}}{S} \qquad ( 1 )$$

Here, the symbol “AVR” in the transfer function G_{AVR(s)} is an abbreviation of an “automatic voltage regulator”. Furthermore, in formula (1) above, the symbol “K_{pAVR}” denotes proportional gain, the symbol “K_{iAVR}” denotes integral gain, and the symbol “s” is a Laplace operator. The proportional gain K_{pAVR} and the integral gain K_{iAVR} can be freely determined in the PI controller. Note that an I controller may be configured with the proportional gain K_{pAVR} is zero, or a P controller may be configured with the integral gain K_{iAVR} is zero.

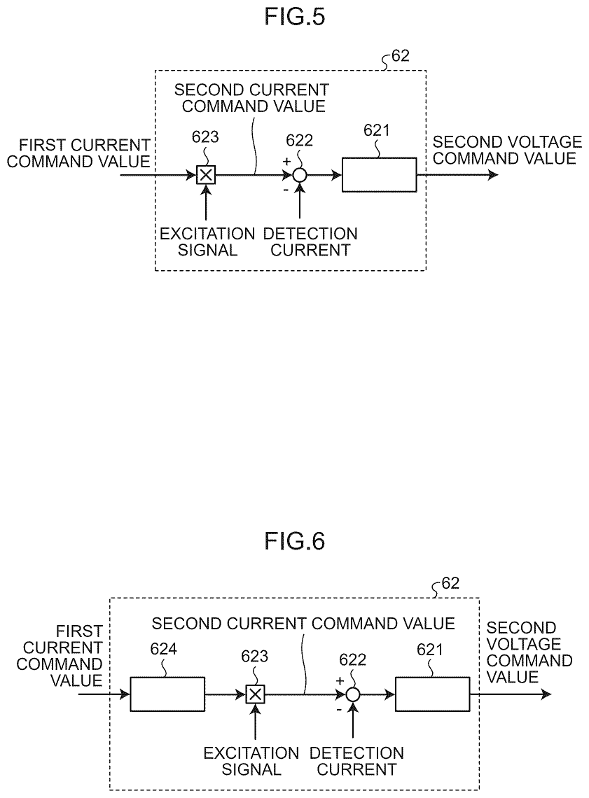

FIG. 5 is a block diagram illustrating an exemplary configuration of the current controller 62 according to the first embodiment. The current controller 62 includes a current control device 621, a subtracter 622, and a multiplier 623. The current controller 62 generates the second voltage command value by using a second current command value obtained as a result of causing the first current command value to follow a sinusoidal wave. More specifically, the multiplier 623 multiplies the first current command value by an excitation signal. The excitation signal is a sinusoidal wave synchronized with the phase of the power supply voltage. The sinusoidal wave is generated based on a voltage phase that is the phase of a detection voltage detected by the voltage detector 217a. Output of the multiplier 623 is input, as the second current command value, to the subtracter 622. The subtracter 622 generates a current deviation that is a difference between the second current command value and a detection current detected by the current detector 211. The current control device 621 generates the second voltage command value by using the current deviation output from the subtracter 622. The current control device 621 may be configured as, for example, a proportional sinusoidal (PS) controller.

In a case where the current control device 621 is configured by a PS controller, a transfer function G_{ACR(s)} can be expressed by formula (2) below.

$$Formula 2$$

$${G}_{ACR ( s )} = {K}_{pACR} + \frac{{K}_{s ACR} s}{{s}^{2} + {ω}_{n}^{2}} \qquad ( 2 )$$

Here, the symbol “ACR” in the transfer function G_{ACR(s)} is an abbreviation of an “automatic current regulator”. Furthermore, in formula (2) above, the symbol “K_{pACR}” denotes proportional gain, the symbol “K_{sACR}” denotes S control gain, the symbol “ωₙ” denotes angular frequency, and the symbol “s” is a Laplace operator. The proportional gain K_{pACR}, the S control gain K_{sACR}, and the angular frequency ωₙ can be freely determined in the PS controller.

The PS controller is a controller in which an S controller, which is a Laplace transform representation of a sine function or a cosine function, is inserted in parallel to a P controller. The S controller is a controller having improved following capability with respect to sinusoidal input of the angular frequency ωₙ. The reason why the following capability is improved with respect to an input pulsating at the angular frequency ωₙ in the S controller can be explained by the internal model principle. The internal model principle states that, if a denominator of a controller has the same factor as a denominator polynomial of a command value expressed by Laplace transform, the command value can be followed without deviation. Note that an I controller may be inserted in parallel to the PS controller to configure the current control device 621 as a PIS controller.

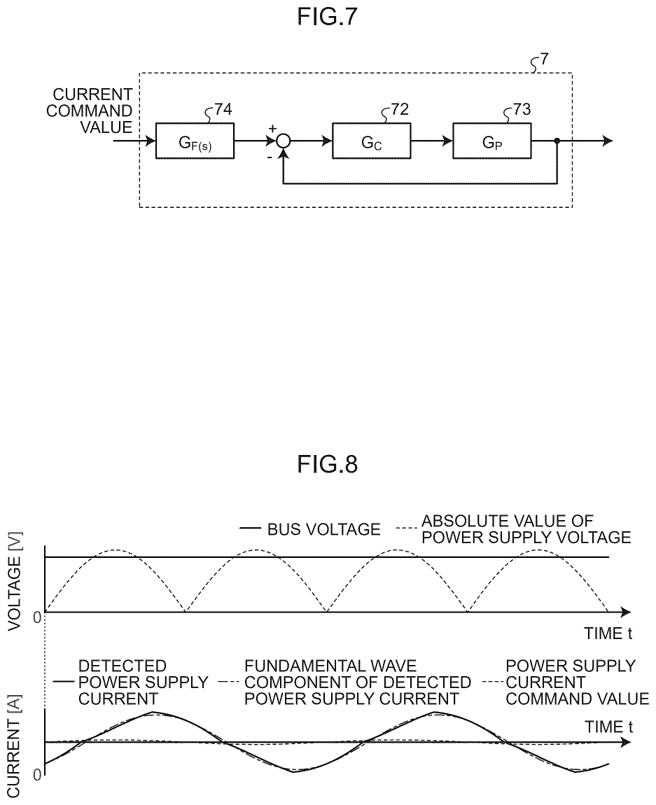

FIG. 6 is a block diagram illustrating an exemplary configuration of the current controller 62 obtained by introducing a target value filter 624 into the current controller 62 illustrated in FIG. 5. In addition, FIG. 7 is a block diagram for describing a transfer function of a current control system 7 in the AC-DC converter 2 including the current controller 62 illustrated in FIG. 6.

In FIG. 6, the target value filter 624 is inserted in an early stage of the current controller 62 illustrated in FIG. 5. The target value filter 624 is inserted so as to adjust response of the transfer function of the current controller 62 illustrated in FIG. 5. Specifically, a zero point of the transfer function of the current controller 62 is caused to be canceled out at a pole of the target value filter 624. Thus, the response of the transfer function of the current controller 62 is adjusted.

Here, a closed-loop transfer function G_{close(s)} in the current control system 7 of FIG. 7 can be expressed by formula (3) below.

$$Formula 3$$

$${G}_{close ( s )} = \frac{{G}_{C} {G}_{P}}{1 + {G}_{C} {G}_{P}} \qquad ( 3 )$$

In formula (3) above, G_{c} denotes a transfer function of any given control device 72, and G_{P} denotes a transfer function of any given to-be-controlled plant 73. When formula (3) above has a zero point, response of a closed loop cannot be determined simply by the pole. Therefore, a target value filter 74 having the same polarity as the zero point of the closed-loop transfer function G_{close(s)} is inserted in an early stage of the closed loop. Then, pole-zero cancellation is performed between a transfer function G_{F(s)} of the target value filter 74 and the closed-loop transfer function G_{close(s)} so as to cancel the influence of the zero point. Thus, a desired response is achieved. After the insertion of the target value filter 74, a transfer function G′_{close(s)} can be expressed by formula (4) below.

$$Formula 4$$

$$\begin{matrix}{G}_{close ( s )}^{′} = {G}_{F ( s )} {G}_{close ( s )} \\ = \frac{{G}_{X}}{{G}_{C} {G}_{P}} \frac{{G}_{C} {G}_{P}}{1 + {G}_{C} {G}_{P}} \\ = \frac{{G}_{X}}{1 + {G}_{C} {G}_{P}}\end{matrix} \qquad ( 4 )$$

In formula (4) above, G_{X} denotes any given transfer function. The transfer function G_{X} may be a value of a zeroth-power term of the Laplace operator “s” in a denominator polynomial of the transfer function G′_{close(s)}. Alternatively, the transfer function G_{X} may have any given zero point. It is possible to adjust controller response by applying the target value filter 74 having the transfer function G_{F(s)} as described above. Note that a PI controller may be used as a controller that obtains an effect similar to that of the target value filter 74.

Next, performance characteristics to be exhibited when PS control is applied to the current control device 621 will be clarified by a comparison with a condition under which the PI controller is applied to the current control device 621.

FIG. 8 is a diagram illustrating exemplary operation waveforms of power supply voltage, bus voltage, and power supply current to be obtained when PI control is applied to the current control device 621 illustrated in FIG. 6. Waveforms of the bus voltage and the absolute value of the power supply voltage are illustrated in an upper part of FIG. 8. Waveforms of detected power supply current, a fundamental wave component of the detected power supply current, and a power supply current command value are illustrated in a lower part of FIG. 8. The detected power supply current refers to a detected waveform of power supply current detected by the current detector 211.

An operating condition that the bus voltage is equal to or less than a peak value of the absolute value of the power supply voltage is illustrated in the upper part of FIG. 8. Under this condition, the rectifier circuitry 20 operates not as a booster circuit but as a capacitor input-type diode rectifier circuitry. Thus, the bus voltage cannot be controlled. At this time, values are excessively accumulated in an integrator for PI control. Therefore, a wind-up phenomenon occurs, and the detected power supply current cannot follow the power supply current command value.

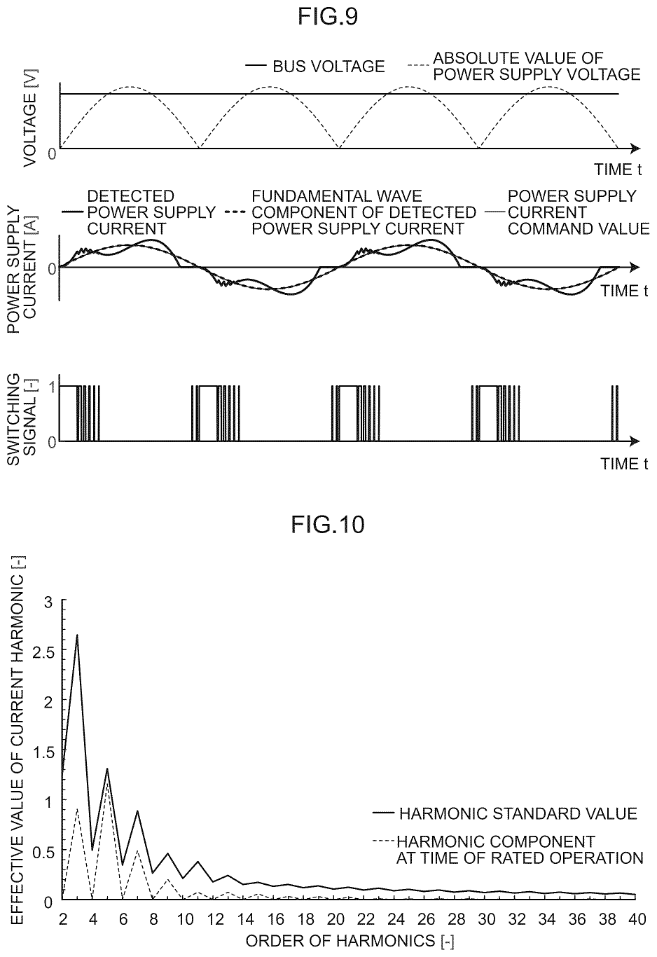

Meanwhile, FIG. 9 is a diagram illustrating exemplary operation waveforms of power supply voltage, bus voltage, and power supply current to be obtained when the PS control is applied to the current control device 621 illustrated in FIG. 6. As with FIG. 8, waveforms of the bus voltage and the absolute value of the power supply voltage are illustrated in an upper part of FIG. 9, and waveforms of detected power supply current, a fundamental wave component of the detected power supply current, and a power supply current command value are illustrated in a middle part of FIG. 9. In addition, a switching signal for controlling the switching element 215 is illustrated in a lower part of FIG. 9.

As illustrated in the middle part of FIG. 9, the fundamental wave component of the detected power supply current substantially coincides with the power supply current command value. This shows that when the PS control with high following capability with respect to sinusoidal input is applied to the current control device 621, the fundamental wave of the detected power supply current can follow the power supply current command value even under the condition that the bus voltage is equal to or less than the peak value of the absolute value of the power supply voltage. Note that although FIG. 9 illustrates a result of the operating condition that the bus voltage is equal to or less than the peak value of the absolute value of the power supply voltage, it goes without saying that the fundamental wave of the detected power supply current follows the power supply current command value even under an operating condition that the bus voltage exceeds the peak value of the absolute value of the power supply voltage.

FIG. 10 is a diagram illustrating exemplary current harmonic characteristics to be exhibited when the PS control is applied to the current control device 621 illustrated in FIG. 6. The current harmonic standard used in FIG. 10 is IEC61000-3-2 Class A. Note that IEC61000-3-2 Class A is an example of the current harmonic standard, and the current harmonic standard is not limited to this example.

In FIG. 10, current harmonic standard values of second to 40th harmonics specified in IEC61000-3-2 class A are indicated by a solid line. Furthermore, in FIG. 10, effective values of the second to 40th harmonic components obtained at the time of rated operation are indicated by a broken line. The harmonic components to be obtained at the time of rated operation represent remaining components to be obtained when the fundamental wave component of power supply current flowing at the time of operation of the AC-DC converter 2 at rated power is eliminated from the power supply current. Note that, in the present specification, the second to 40th harmonics are defined as “low-order harmonics”.

According to FIG. 10, the broken-line waveform is lower than the solid-line waveform for the second to 40th harmonics. This shows that when the PS control with high following capability with respect to sinusoidal input is applied to the current control device 621, the low-order harmonics included in the power supply current conform to harmonic standard values of the power supply current. Note that the harmonic components to be obtained at the time of rated operation are exemplified in FIG. 10, but it goes without saying that the effect of reducing the harmonic components by the PS control can also be obtained in cases other than the rated operation.

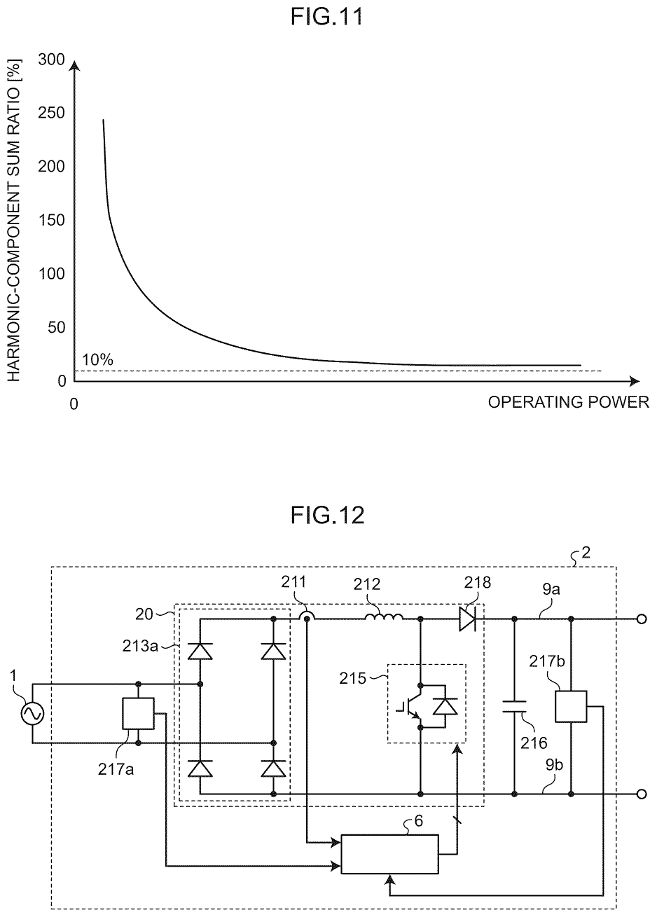

FIG. 11 is a diagram illustrating an exemplary relationship between a harmonic-component sum ratio and operating power to be exhibited when the PS control is applied to the current control device 621 illustrated in FIG. 6. Here, the harmonic-component sum ratio refers to the ratio of the sum of second and higher harmonic components to the fundamental wave of the power supply current.

According to FIG. 11, it can be seen that the harmonic-component sum ratio is 10% or more in an entire operating range illustrated in FIG. 11. The harmonic-component sum ratio being 10% or more is unique to the method of the first embodiment in which the switching element 215 is controlled by application of the PS control to the current control device 621. When operating power is small, the harmonic-component sum ratio increases, but the harmonic standard values also increase when the operating power is small. Thus, the effective values of current harmonics do not exceed the harmonic standard values of the power supply current as illustrated in FIG. 10.

The control method of the first embodiment is characterized in that the current control device 621 is applied to the controller 6, and in addition, the PS control with high following capability with respect to sinusoidal input is applied to the current control device 621. It is considered that applying the PS control so as to enhance the following capability with respect to sinusoidal input is relatively widely performed. Meanwhile, it is considered that applying the PS control so as to conform to the harmonic standard is an unprecedented new method.

As described above, the AC-DC converter according to the first embodiment includes: a rectifier circuitry configured to rectify power supply voltage applied from an AC power supply; a capacitor configured to smooth output voltage of the rectifier circuitry; and a reactor disposed closer to the AC power supply than the capacitor. The rectifier circuitry includes at least one switching element disposed closer to the AC power supply than the capacitor. When generating a switching signal for controlling a switching element, the controller is configured to generate the switching signal such that a harmonic component included in power supply current conforms to a harmonic standard value of the power supply current, the power supply current flowing between the AC power supply and the rectifier circuitry. The AC-DC converter according to the first embodiment makes it possible to conform to the harmonic standard without relying on a trial-and-error adjustment method in which conformity with the harmonic standard is checked by repeated trials. In addition, the AC-DC converter according to the first embodiment makes it possible to conform to the harmonic standard while improving an input power factor even under the operating condition that the bus voltage exceeds the peak value of the absolute value of the power supply voltage.

In order to implement the above function, the controller according to the first embodiment includes: a voltage controller configured to generate a first current command value by using a first voltage command value that is a command value of bus voltage; a current controller configured to generate a second voltage command value by using a second current command value that is obtained as a result of causing the first current command value to follow a sinusoidal wave; and a switching signal generator configured to generate the switching signal by using the second voltage command value. The current controller includes a current control device, and the PS control is applied to the current control device. In addition, a filter is provided at an input stage of the current controller. The filter manipulates a zero point of a feedback loop in which the second voltage command value output from the current controller is fed back to an input stage of the second current command value. When the controller configured as described above is used, it is not necessary to repeat design for each load power, regarding whether a combination of reactor capacity and switching timing can conform to the harmonic standard. Therefore, trial-and-error adjustment work is eliminated, and the time required for design work and the time until design completion can be shortened.

Note that when the switching element is controlled by means of the controller configured as described above, low-order harmonics are superimposed on the power supply current flowing between the AC power supply and the AC-DC converter. Furthermore, the sum of harmonic components of the power supply current is 10% or more of the fundamental wave of the power supply current.

In addition, when a control system of the AC-DC converter is configured as a closed loop, the AC-DC converter includes: a current detector configured to detect the power supply current flowing between the AC power supply and the rectifier circuitry; a first voltage detector configured to detect the bus voltage; and a second voltage detector configured to detect the power supply voltage. In a case where the control system of the AC-DC converter is configured as a closed loop, the first current command value just needs to be generated by use of a voltage deviation that is a difference between the first voltage command value and a detection voltage, the detection voltage being detected by the first voltage detector, and the sinusoidal wave that excites the first current command value just needs to be generated based on a voltage phase detected by the second voltage detector. Furthermore, the second voltage command value just needs to be generated by use of a current deviation that is a difference between the second current command value and a detection current that is detected by the current detector.

### Second Embodiment

In the first embodiment, a description has been given of the configuration in which the PS control is applied to the current control device 621 of the current controller 62 for the purpose of improving the following capability with respect to a sinusoidal command. In a second embodiment, a description will be given of a configuration in which proportional integral resonant (PIR) control is applied to the current control device 621 of the current controller 62 for the same purpose.

FIG. 12 is a diagram illustrating an exemplary configuration of the AC-DC converter 2 according to the second embodiment. Components having the same or equivalent functions as those of the components in FIG. 2 are denoted by the same reference numerals. Note that description of an overlap between the first embodiment and the second embodiment will be omitted as appropriate.

The rectifier circuitry 20 illustrated in FIG. 12 has a configuration called a full pulse amplitude modulation (PAM) circuit. The rectifier circuitry 20 includes the single-phase diode bridge cell 213a, the switching element 215, and a diode 218. In the single-phase diode bridge cell 213a, the switching element 215 performs switching operation at least once in a half cycle of the power supply voltage.

The reactor 212 described with reference to the configuration of FIG. 2 is disposed between the single-phase diode bridge cell 213a and the diode 218. The switching element 215 is located between the single-phase diode bridge cell 213a and the capacitor 216 and connected in parallel to the single-phase diode bridge cell 213a and the capacitor 216. In addition, the current detector 211 described with reference to the configuration of FIG. 2 is disposed between the single-phase diode bridge cell 213a and the diode 218.

Locations and connection modes of the switching element 215 and the reactor 212 differ between the configurations of FIGS. 2 and 12. Meanwhile, the switching element 215 and the reactor 212 are disposed closer to the AC power supply 1 than the capacitor 216 in either configuration. The same applies to other embodiments to be described below.

Note that although the switching element 215 is represented as an IGBT in FIG. 12, any element may be used as long as switching operation can be performed. In addition, the AC-DC converter 2 illustrated in FIG. 12 is configured as a closed loop, but may be configured as an open loop. In a case where the AC-DC converter 2 is configured as an open loop, detection values of the voltage detectors 217a and 217b and the current detector 211 need not be used.

Furthermore, the full PAM circuit of FIG. 12 may be used in the first embodiment, and the simple switching circuit of FIG. 2 may be used in the second embodiment. That is, when the AC-DC converter 2 has a step-up function or a step-down function, the rectifier circuitry 20 includes at least one switching element, but the control method described in the present specification can be applied even if a control system for controlling the switching element is different.

Next, a transfer function of a PIR controller will be described. First, a transfer function G_{PIR(s)} of the PIR controller can be expressed by formula (5) below.

$$Formula 5$$

$${G}_{PIR ( s )} = {K}_{p} + \frac{{K}_{i}}{s} + \frac{2 {ω}_{1} {K}_{r} s}{{s}^{2} + 2 {ω}_{1} s + {ω}_{2}^{2}} \qquad ( 5 )$$

In formula (5) above, Kₚ denotes proportional gain, Kᵢ denotes integral gain, Kᵣ denotes resonance control gain, ω₁ denotes angular frequency of current control response, and ω₂ denotes angular frequency of a sinusoidal command to be followed. A PIR controller having the transfer function G_{PIR(s)} as described above may be applied to the current control device 621 of FIG. 5 or 6. It is also possible to obtain the same effect as the PS control by using the PIR controller.

As described above, the PIR control is applied to the current control device included in the current controller in the controller according to the second embodiment. Even in a case where the PIR control is applied instead of the PS control, the same effect as that of the first embodiment can be obtained.

### Third Embodiment

In a third embodiment, a description will be given of an example different from the above example of the AC-DC converter 2 including the controller 6 described in the first embodiment or the second embodiment. Note that components having the same or equivalent functions as the components of the AC-DC converter 2 described in the first and second embodiments are denoted by the same reference numerals, and redundant descriptions will be omitted.

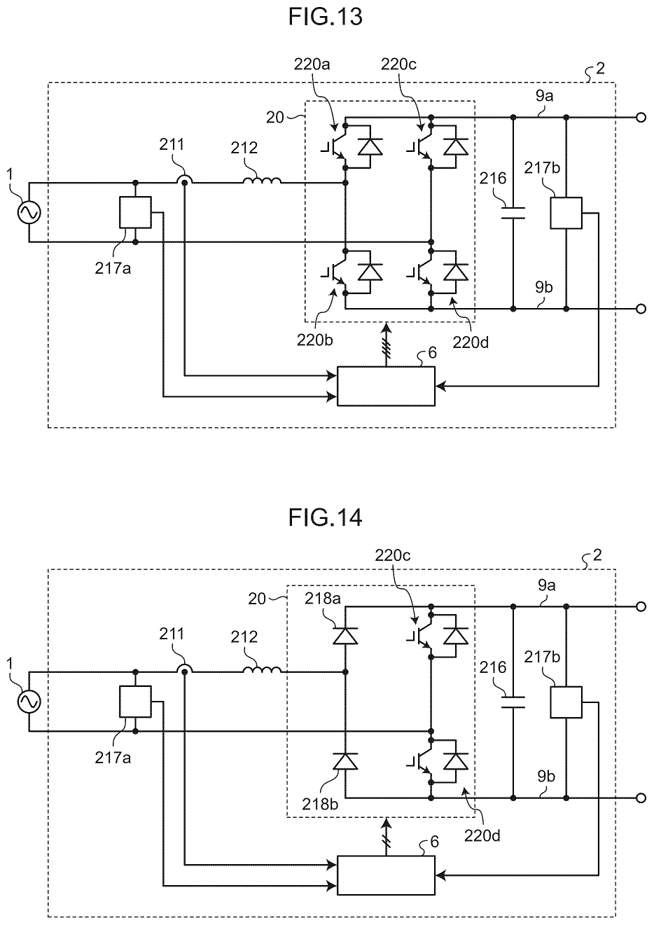

FIG. 13 is a diagram illustrating an exemplary configuration of the AC-DC converter 2 according to the third embodiment. In the AC-DC converter 2 of FIG. 13, the rectifier circuitry 20 is configured as a single-phase H bridge cell including four switching elements 220a, 220b, 220c, and 220d. Note that the configuration and operation of the rectifier circuitry 20 illustrated in FIG. 13 are known, and further description thereof is omitted here.

The controller 6 generates switching signals for the four switching elements 220a, 220b, 220c, and 220d and drives the four switching elements 220a, 220b, 220c, and 220d by using the control method described in the first embodiment or the second embodiment. As a result, the same effect as that of the first embodiment or the second embodiment can be obtained also in the AC-DC converter 2 illustrated in FIG. 13.

Note that although the switching elements 220a, 220b, 220c, and 220d are represented as IGBTs in FIG. 13, any elements may be used as long as switching operation can be performed. Furthermore, the AC-DC converter 2 illustrated in FIG. 13 is configured as a closed loop, but may be configured as an open loop. In a case where the AC-DC converter 2 is configured as an open loop, detection values of the voltage detectors 217a and 217b and the current detector 211 need not be used.

### Fourth Embodiment

In a fourth embodiment, a description will be given of an example different from the above example of the AC-DC converter 2 including the controller 6 described in the first embodiment or the second embodiment. Note that components having the same or equivalent functions as the components of the AC-DC converter 2 described in the first and second embodiments are denoted by the same reference numerals, and redundant descriptions will be omitted.

FIG. 14 is a diagram illustrating an exemplary configuration of the AC-DC converter 2 according to the fourth embodiment. In the AC-DC converter 2 of FIG. 14, the rectifier circuitry 20 is configured as a single-phase H bridge cell including two diodes 218a and 218b and two switching elements 220c and 220d. In the rectifier circuitry 20 illustrated in FIG. 14, one of legs is configured as a series circuit of the diodes 218a and 218b, and another of the legs is configured as a series circuit of the switching elements 220c and 220d. Note that the configuration and operation of the rectifier circuitry 20 illustrated in FIG. 14 are known, and further description thereof is omitted here.

The controller 6 generates switching signals for the two switching elements 220c and 220d and drives the two switching elements 220c and 220d by using the control method described in the first embodiment or the second embodiment. As a result, the same effect as that of the first embodiment or the second embodiment can be obtained also in the AC-DC converter 2 illustrated in FIG. 14.

Note that although the switching elements 220c and 220d are represented as IGBTs in FIG. 14, any elements may be used as long as switching operation can be performed. In addition, the AC-DC converter 2 illustrated in FIG. 14 is configured as a closed loop, but may be configured as an open loop. In a case where the AC-DC converter 2 is configured as an open loop, detection values of the voltage detectors 217a and 217b and the current detector 211 need not be used.

### Fifth Embodiment

In a fifth embodiment, a description will be given of an example different from the above example of the AC-DC converter 2 including the controller 6 described in the first embodiment or the second embodiment. Note that components having the same or equivalent functions as the components of the AC-DC converter 2 described in the first and second embodiments are denoted by the same reference numerals, and redundant descriptions will be omitted.

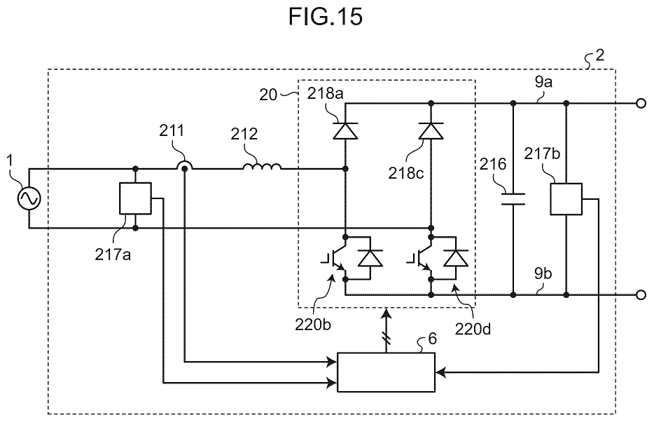

FIG. 15 is a diagram illustrating an exemplary configuration of the AC-DC converter 2 according to the fifth embodiment. In the AC-DC converter 2 of FIG. 15, the rectifier circuitry 20 is configured as a single-phase H bridge cell including two diodes 218a and 218c and two switching elements 220b and 220d. In the rectifier circuitry 20 illustrated in FIG. 15, the diodes 218a and 218c are disposed on upper arms of two legs, and the switching elements 220b and 220d are disposed on lower arms of the two legs. Note that the configuration and operation of the rectifier circuitry 20 illustrated in FIG. 15 are known, and further description thereof is omitted here.

The controller 6 generates switching signals for the two switching elements 220b and 220d and drives the two switching elements 220b and 220d by using the control method described in the first embodiment or the second embodiment. As a result, the same effect as that of the first embodiment or the second embodiment can be obtained also in the AC-DC converter 2 illustrated in FIG. 15.

Note that although the switching elements 220b and 220d are represented as IGBTs in FIG. 15, any elements may be used as long as switching operation can be performed. Furthermore, the AC-DC converter 2 illustrated in FIG. 15 is configured as a closed loop, but may be configured as an open loop. In a case where the AC-DC converter 2 is configured as an open loop, detection values of the voltage detectors 217a and 217b and the current detector 211 need not be used.

### Sixth Embodiment

In a sixth embodiment, a description will be given of an example different from the above example of the AC-DC converter 2 including the controller 6 described in the first embodiment or the second embodiment. Note that components having the same or equivalent functions as the components of the AC-DC converter 2 described in the first and second embodiments are denoted by the same reference numerals, and redundant descriptions will be omitted.

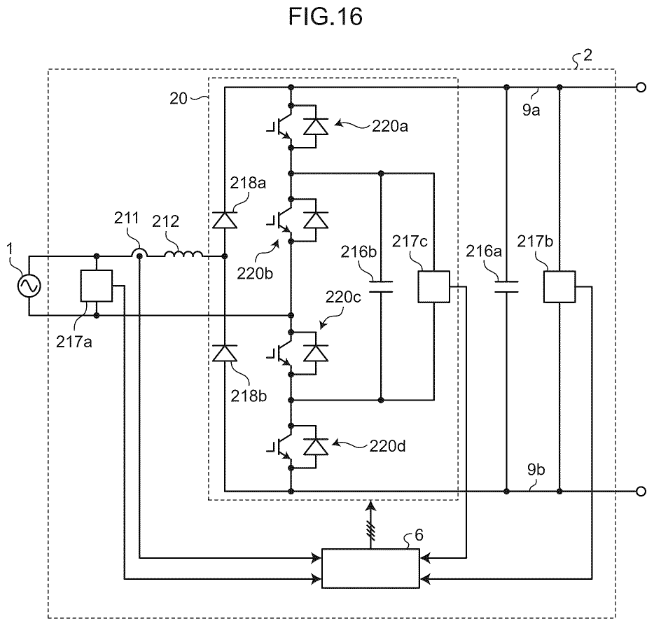

FIG. 16 is a diagram illustrating an exemplary configuration of the AC-DC converter 2 according to the sixth embodiment. In the AC-DC converter 2 of FIG. 16, the rectifier circuitry 20 is configured as a single-phase H bridge cell including two diodes 218a and 218b, four switching elements 220a, 220b, 220c, and 220d, a capacitor 216b, and a voltage detector 217c. The voltage detector 217c may be provided outside the rectifier circuitry 20.

In the rectifier circuitry 20 illustrated in FIG. 16, one of legs is configured as a series circuit of the diodes 218a and 218b, and another of the legs is configured as a series circuit of the switching elements 220a, 220b, 220c, and 220d. The capacitor 216b is connected between a connection point of the switching elements 220a and 220b and a connection point of the switching elements 220c and 220d. The voltage detector 217c detects voltage of the capacitor 216b, and outputs a detection value thereof to the controller 6. The controller 6 generates switching signals for controlling the switching elements 220a, 220b, 220c, and 220d based on respective detection values of the voltage detectors 217a, 217b, and 217c and the current detector 211. Note that the configuration and operation of the rectifier circuitry 20 illustrated in FIG. 16 are known, and further description thereof is omitted here.

The controller 6 generates switching signals for the four switching elements 220a, 220b, 220c, and 220d and drives the four switching elements 220a, 220b, 220c, and 220d by using the control method described in the first embodiment or the second embodiment. As a result, the same effect as that of the first embodiment or the second embodiment can be obtained also in the AC-DC converter 2 illustrated in FIG. 16.

Note that although the switching elements 220a, 220b, 220c, and 220d are represented as IGBTs in FIG. 16, any elements may be used as long as switching operation can be performed. In addition, the AC-DC converter 2 illustrated in FIG. 16 is configured as a closed loop, but may be configured as an open loop. In a case where the AC-DC converter 2 is configured as an open loop, the detection values of the voltage detectors 217a, 217b, and 217c and the current detector 211 need not be used.

### Seventh Embodiment

In a seventh embodiment, a description will be given of an example different from the above example of the AC-DC converter 2 including the controller 6 described in the first embodiment or the second embodiment. Note that components having the same or equivalent functions as the components of the AC-DC converter 2 described in the first and second embodiments are denoted by the same reference numerals, and redundant descriptions will be omitted.

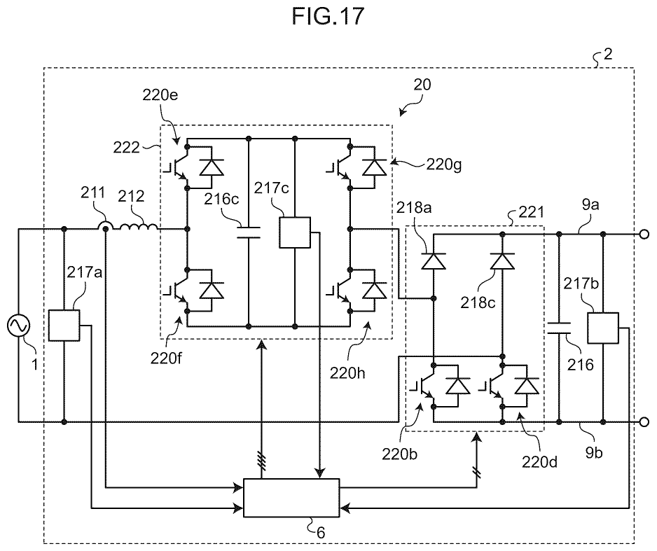

FIG. 17 is a diagram illustrating an exemplary configuration of the AC-DC converter 2 according to the seventh embodiment. In the AC-DC converter 2 of FIG. 17, the rectifier circuitry 20 includes a single-phase H bridge cell 221 and a switching cell 222. The single-phase H bridge cell 221 includes two diodes 218a and 218c and two switching elements 220b and 220d. The switching cell 222 includes four switching elements 220e, 220f, 220g, and 220h, a capacitor 216c, and the voltage detector 217c. The voltage detector 217c may be provided outside the switching cell 222.

In the single-phase H bridge cell 221 illustrated in FIG. 17, the diodes 218a and 218c are disposed on upper arms of two legs, and the switching elements 220b and 220d are disposed on lower arms of the two legs. Furthermore, the four switching elements 220e, 220f, 220g, and 220h are bridge-connected in the switching cell 222 illustrated in FIG. 17. The capacitor 216c is connected in parallel to a first leg including the switching elements 220e and 220f and a second leg including the switching elements 220g and 220h.

The voltage detector 217c detects voltage of the capacitor 216c, and outputs a detection value thereof to the controller 6. The controller 6 generates switching signals for controlling the switching elements 220b, 220d, 220e, 220f, 220g, and 220h based on respective detection values of the voltage detectors 217a, 217b, and 217c and the current detector 211. Note that the configuration and operation of the rectifier circuitry 20 illustrated in FIG. 17 are known, and further description thereof is omitted here.

The controller 6 generates switching signals for the six switching elements 220b, 220d, 220e, 220f, 220g, and 220h and drives the six switching elements 220b, 220d, 220e, 220f, 220g, and 220h by using the control method described in the first embodiment or the second embodiment. As a result, the same effect as that of the first embodiment or the second embodiment can be obtained also in the AC-DC converter 2 illustrated in FIG. 17.

Note that although the switching elements 220b, 220d, 220e, 220f, 220g, and 220h are represented as IGBTs in FIG. 17, any elements may be used as long as switching operation can be performed. In addition, the AC-DC converter 2 illustrated in FIG. 17 is configured as a closed loop, but may be configured as an open loop. In a case where the AC-DC converter 2 is configured as an open loop, the detection values of the voltage detectors 217a, 217b, and 217c and the current detector 211 need not be used.

### Eighth Embodiment

In an eighth embodiment, a description will be given of an example different from the above example of the AC-DC converter 2 including the controller 6 described in the first embodiment or the second embodiment. Note that components having the same or equivalent functions as the components of the AC-DC converter 2 described in the first and second embodiments are denoted by the same reference numerals, and redundant descriptions will be omitted,

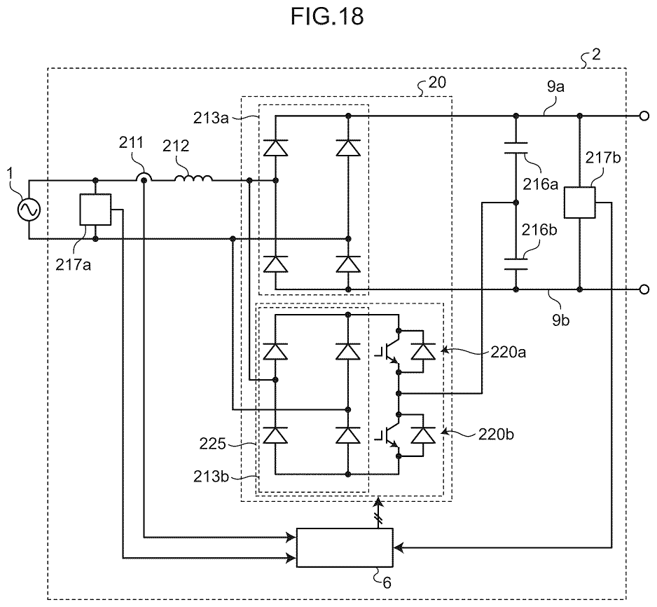

FIG. 18 is a diagram illustrating an exemplary configuration of the AC-DC converter 2 according to the eighth embodiment. In the AC-DC converter 2 of FIG. 18, the rectifier circuitry 20 includes the single-phase diode bridge cell 213a and the switching cell 225. The switching cell 225 includes the single-phase diode bridge cell 213b and a series circuit including two switching elements 220a and 220b. The series circuit is connected in parallel to the single-phase diode bridge cell 213b. In FIG. 18, the capacitor 216 of FIG. 2 has been replaced with two capacitors 216a and 216b connected in series. The capacitors 216a and 216b connected in series are connected between the DC buses 9a and 9b.

The controller 6 generates switching signals for controlling the switching elements 220a and 220b based on respective detection values of the voltage detectors 217a and 217b and the current detector 211. Note that the configuration and operation of the rectifier circuitry 20 illustrated in FIG. 18 are known, and further description thereof is omitted here.

The controller 6 generates switching signals for the two switching elements 220a and 220b and drives the two switching elements 220a and 220b by using the control method described in the first embodiment or the second embodiment. As a result, the same effect as that of the first embodiment or the second embodiment can be obtained also in the AC-DC converter 2 illustrated in FIG. 18.

Note that although the switching elements 220a and 220b are represented as IGBTs in FIG. 18, any elements may be used as long as switching operation can be performed. Furthermore, the AC-DC converter 2 illustrated in FIG. 18 is configured as a closed loop, but may be configured as an open loop. In a case where the AC-DC converter 2 is configured as an open loop, detection values of the voltage detectors 217a and 217b and the current detector 211 need not be used.

### Ninth Embodiment

In a ninth embodiment, a description will be given of an example different from the above example of the AC-DC converter 2 including the controller 6 described in the first embodiment or the second embodiment. Note that components having the same or equivalent functions as the components of the AC-DC converter 2 described in the first and second embodiments are denoted by the same reference numerals, and redundant descriptions will be omitted.

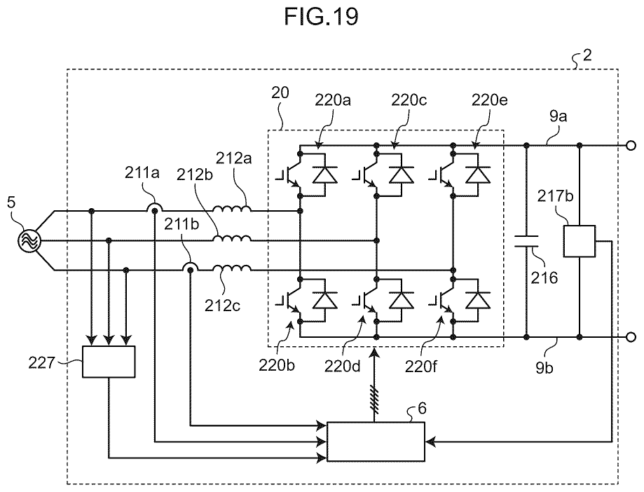

FIG. 19 is a diagram illustrating an exemplary configuration of the AC-DC converter 2 according to the ninth embodiment. FIG. 13 illustrates the AC-DC converter 2 including the AC power supply 1 that is a single-phase AC power supply. Meanwhile, the AC power supply 1 has been changed to a three-phase AC power supply 5 in FIG. 19. As a result, in the AC-DC converter 2 of FIG. 19, the rectifier circuitry 20 includes a three-phase full-bridge cell 226 including six switching elements 220a, 220b, 220c, 220d, 220e, and 220f. Reactors 212a, 212b, and 212c are each inserted into corresponding one of three phases between the three-phase AC power supply 5 and the rectifier circuitry 20, and current detectors 211a and 211b are disposed in any two of the three phases.

A voltage detector 227 detects voltage of each phase of the three-phase AC power supply 5, and outputs each detection value to the controller 6. The current detectors 211a and 211b detect currents flowing through the any two of the three phases, and output detection values thereof to the controller 6. It is possible to obtain a current flowing through remaining one phase by calculation performed inside the controller 6 based on the fact that the respective currents of the three phases are in three-phase equilibrium.

The controller 6 generates switching signals for controlling the switching elements 220a, 220b, 220c, 220d, 220e, and 220f based on respective detection values of the voltage detectors 227 and 217b and the current detectors 211a and 211b. Note that the configuration and operation of the rectifier circuitry 20 illustrated in FIG. 19 are known, and further description thereof is omitted here.

The controller 6 generates switching signals for the six switching elements 220a, 220b, 220c, 220d, 220e, and 220f and drives the six switching elements 220a, 220b, 220c, 220d, 220e, and 220f by using the control method described in the first embodiment or the second embodiment. As a result, the same effect as that of the first embodiment or the second embodiment can be obtained also in the AC-DC converter 2 illustrated in FIG. 19.

Note that although the switching elements 220a, 220b, 220c, 220d, 220e, and 220f are represented as IGBTs in FIG. 19, any elements may be used as long as switching operation can be performed. Furthermore, the AC-DC converter 2 illustrated in FIG. 19 is configured as a closed loop, but may be configured as an open loop. In a case where the AC-DC converter 2 is configured as an open loop, the detection values of the voltage detectors 227 and 217b and the current detectors 211a and 211b need not be used. In addition, the control according to the ninth embodiment may be performed on α, β coordinates or on three-phase coordinates.

### Tenth Embodiment

In a tenth embodiment, a description will be given of an example different from the above example of the AC-DC converter 2 including the controller 6 described in the first embodiment or the second embodiment. Note that components having the same or equivalent functions as the components of the AC-DC converter 2 described in the first, second, and ninth embodiments are denoted by the same reference numerals, and redundant descriptions will be omitted.

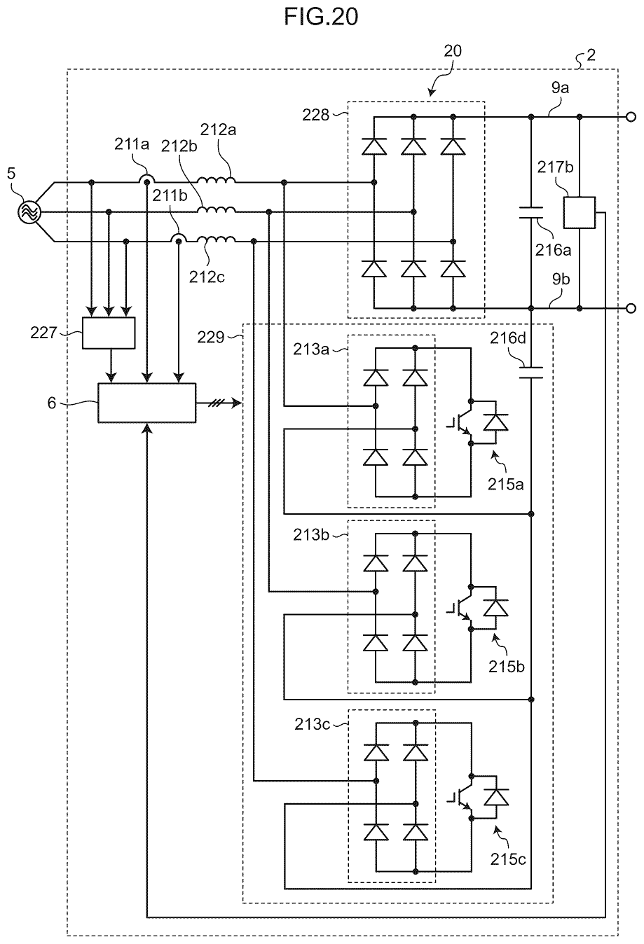

FIG. 20 is a diagram illustrating an exemplary configuration of the AC-DC converter 2 according to the tenth embodiment. In the AC-DC converter 2 of FIG. 20, the rectifier circuitry 20 includes a three-phase diode bridge cell 228 and a three-phase simplified PAM cell 229. The three-phase diode bridge cell 228 includes six diodes that are full-bridge connected. The three-phase simplified PAM cell 229 includes: single-phase diode bridge cells 213a, 213b, and 213c; and switching elements 215a, 215b, and 215c connected in parallel to the single-phase diode bridge cells 213a, 213b, and 213c, respectively. The single-phase diode bridge cells 213a, 213b, and 213c are connected to three-phase lines between the reactors 212a, 212b, and 212c and the three-phase diode bridge cell 228, respectively. In addition, the three-phase simplified PAM cell 229 includes a capacitor 216d having one end connected to the single-phase diode bridge cells 213a, 213b, and 213c and an opposite end connected to the DC bus 9b. The capacitor 216d may be provided outside the three-phase simplified PAM cell 229.

The controller 6 generates switching signals for controlling the switching elements 215a, 215b, and 215c based on respective detection values of the voltage detectors 227 and 227b and the current detectors 211a and 211b. Note that the configuration and operation of the rectifier circuitry 20 illustrated in FIG. 20 are known, and further description thereof is omitted here.

The controller 6 generates switching signals for the three switching elements 215a, 215b, and 215c and drives the three switching elements 215a, 215b, and 215c by using the control method described in the first embodiment or the second embodiment. As a result, the same effect as that of the first embodiment or the second embodiment can be obtained also in the AC-DC converter 2 illustrated in FIG. 20.

Note that although the switching elements 215a, 215b, and 215c are represented as IGBTs in FIG. 20, any elements may be used as long as switching operation can be performed. In addition, the AC-DC converter 2 illustrated in FIG. 20 is configured as a closed loop, but may be configured as an open loop. In a case where the AC-DC converter 2 is configured as an open loop, the detection values of the voltage detectors 227 and 217b and the current detectors 211a and 211b need not be used. Furthermore, the control according to the tenth embodiment may be performed on the α, β coordinates or on the three-phase coordinates.

### Eleventh Embodiment

In an eleventh embodiment, a description will be given of an example different from the above example of the AC-DC converter 2 including the controller 6 described in the first embodiment or the second embodiment. Note that components having the same or equivalent functions as the components of the AC-DC converter 2 described in the first, second, ninth, and tenth embodiments are denoted by the same reference numerals, and redundant descriptions will be omitted.

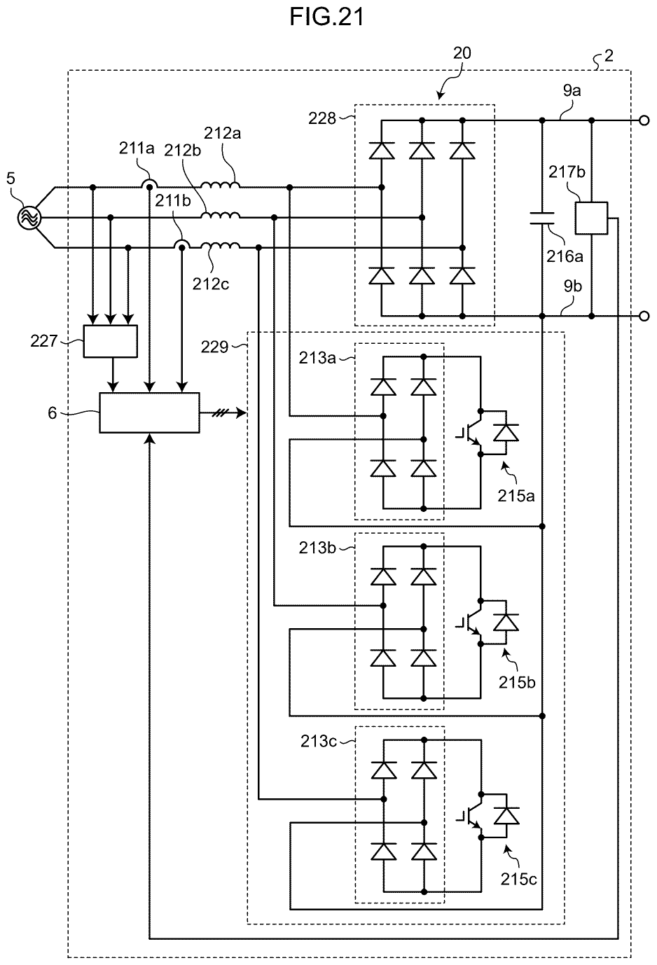

FIG. 21 is a diagram illustrating an exemplary configuration of the AC-DC converter 2 according to the eleventh embodiment. The capacitor 216d in the configuration of the AC-DC converter 2 of FIG. 20 has been removed therefrom to obtain the AC-DC converter 2 of FIG. 21. Except for this point, the configuration of the AC-DC converter 2 of FIG. 21 is the same as or equivalent to the configuration of the AC-DC converter 2 of FIG. 20.

The controller 6 generates switching signals for controlling the switching elements 215a, 215b, and 215c based on respective detection values of the voltage detectors 227 and 217b and the current detectors 211a and 211b. Note that the configuration and operation of the rectifier circuitry 20 illustrated in FIG. 21 are known, and further description thereof is omitted here.

The controller 6 generates switching signals for the three switching elements 215a, 215b, and 215c and drives the three switching elements 215a, 215b, and 215c by using the control method described in the first embodiment or the second embodiment. As a result, the same effect as that of the first embodiment or the second embodiment can be obtained also in the AC-DC converter 2 illustrated in FIG. 21.

Note that although the switching elements 215a, 215b, and 215c are represented as IGBTs in FIG. 21, any elements may be used as long as switching operation can be performed. In addition, the AC-DC converter 2 illustrated in FIG. 21 is configured as a closed loop, but may be configured as an open loop. In a case where the AC-DC converter 2 is configured as an open loop, the detection values of the voltage detectors 227 and 217b and the current detectors 211a and 211b need not be used. Furthermore, the control according to the eleventh embodiment may be performed on the α, β coordinates or on the three-phase coordinates.

### Twelfth Embodiment

In a twelfth embodiment, a description will be given of an example different from the above example of the AC-DC converter 2 including the controller 6 described in the first embodiment or the second embodiment. Note that components having the same or equivalent functions as the components of the AC-DC converter 2 described in the first, second, and ninth embodiments are denoted by the same reference numerals, and redundant descriptions will be omitted.

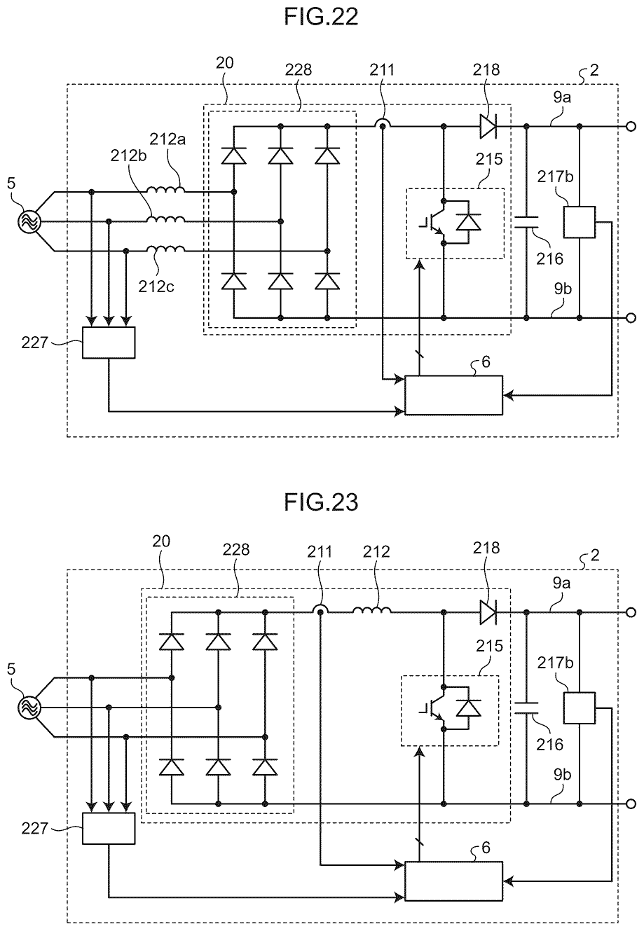

FIG. 22 is a diagram illustrating an exemplary configuration of the AC-DC converter 2 according to the twelfth embodiment. In the AC-DC converter 2 of FIG. 22, the rectifier circuitry 20 has a configuration called a full PAM circuit. The rectifier circuitry 20 includes the three-phase diode bridge cell 228, the switching element 215, and the diode 218.

The controller 6 generates a switching signal for controlling the switching element 215 based on respective detection values of the voltage detectors 227 and 217b and the current detector 211. Note that the configuration and operation of the rectifier circuitry 20 illustrated in FIG. 22 are known, and further description thereof is omitted here.

The controller 6 generates a switching signal for the switching element 215 and drives the switching element 215 by using the control method described in the first embodiment or the second embodiment. As a result, the same effect as that of the first embodiment or the second embodiment can be obtained also in the AC-DC converter 2 illustrated in FIG. 22.

Note that although the switching element 215 is represented as an IGBT in FIG. 22, any element may be used as long as switching operation can be performed. In addition, the AC-DC converter 2 illustrated in FIG. 22 is configured as a closed loop, but may be configured as an open loop. In a case where the AC-DC converter 2 is configured as an open loop, the detection values of the voltage detectors 227 and 217b and the current detector 211 need not be used. Furthermore, the control according to the twelfth embodiment may be performed on the α, β coordinates or on the three-phase coordinates.

### Thirteenth Embodiment

In a thirteenth embodiment, a description will be given of an example different from the above example of the AC-DC converter 2 including the controller 6 described in the first embodiment or the second embodiment. Note that components having the same or equivalent functions as the components of the AC-DC converter 2 described in the first, second, ninth, and twelfth embodiments are denoted by the same reference numerals, and redundant descriptions will be omitted.

FIG. 23 is a diagram illustrating an exemplary configuration of the AC-DC converter 2 according to the thirteenth embodiment. In the AC-DC converter 2 of FIG. 23, the reactors 212a, 212b, and 212c disposed between the three-phase AC power supply 5 and the three-phase diode bridge cell 228 in the configuration of the AC-DC converter 2 of FIG. 22 has been replaced with the reactor 212. In FIG. 23, the reactor 212 is disposed between the three-phase diode bridge cell 228 and the diode 218. Except for this point, the configuration of the AC-DC converter 2 of FIG. 23 is the same as or equivalent to the configuration of the AC-DC converter 2 of FIG. 22.

The controller 6 generates a switching signal for controlling the switching element 215 based on respective detection values of the voltage detectors 227 and 217b and the current detector 211. Note that the configuration and operation of the rectifier circuitry 20 illustrated in FIG. 23 are known, and further description thereof is omitted here.

The controller 6 generates a switching signal for the switching element 215 and drives the switching element 215 by using the control method described in the first embodiment or the second embodiment. As a result, the same effect as that of the first embodiment or the second embodiment can be obtained also in the AC-DC converter 2 illustrated in FIG. 23.

Note that although the switching element 215 is represented as an IGBT in FIG. 23, any element may be used as long as switching operation can be performed. In addition, the AC-DC converter 2 illustrated in FIG. 23 is configured as a closed loop, but may be configured as an open loop. In a case where the AC-DC converter 2 is configured as an open loop, the detection values of the voltage detectors 227 and 217b and the current detector 211 need not be used. Furthermore, the control according to the thirteenth embodiment may be performed on the α, β coordinates or on the three-phase coordinates.

### Fourteenth Embodiment

In a fourteenth embodiment, a description will be given of an example different from the above example of the AC-DC converter 2 including the controller 6 described in the first embodiment or the second embodiment. Note that components having the same or equivalent functions as the components of the AC-DC converter 2 described in the first, second, and ninth embodiments are denoted by the same reference numerals, and redundant descriptions will be omitted.

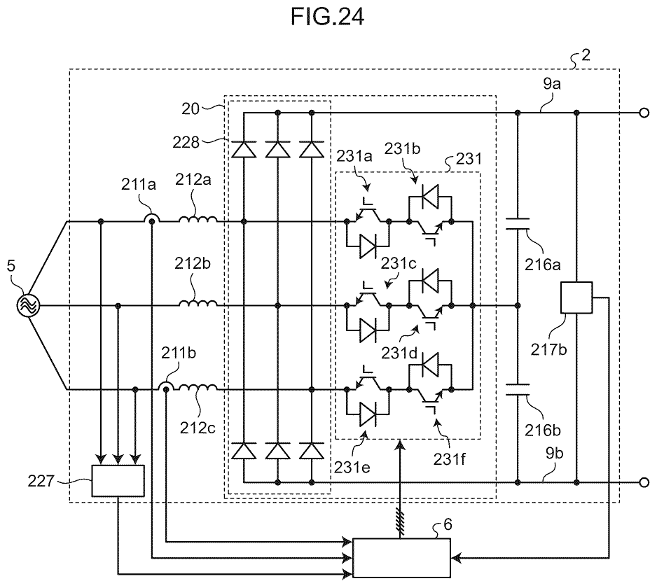

FIG. 24 is a diagram illustrating an exemplary configuration of the AC-DC converter 2 according to the fourteenth embodiment. In the AC-DC converter 2 of FIG. 24, the rectifier circuitry 20 includes the three-phase diode bridge cell 228 and a three-phase bidirectional switching cell 231. The three-phase bidirectional switching cell 231 includes six switching elements 231a, 231b, 231c, 231d, 231e, and 231f. Furthermore, in FIG. 24, the capacitor 216 of FIG. 19 has been replaced with two capacitors 216a and 216b connected in series. The capacitors 216a and 216b connected in series are connected between the DC buses 9a and 9b. In the three-phase bidirectional switching cell 231, the switching elements 231a and 231b are used in a pair and connected in series, the switching elements 231c and 231d are used in a pair and connected in series, and the switching elements 231e and 231f are used in a pair and connected in series. Each pair connected in series for corresponding one of the three phases is disposed between the three-phase diode bridge cell 228 and a connection point of the capacitors 216a and 216b. Note that the configuration and operation of the rectifier circuitry 20 illustrated in FIG. 24 are known, and further description thereof is omitted here.

The controller 6 generates switching signals for the six switching elements 231a, 231b, 231c, 231d, 231e, and 231f and drives the six switching elements 231a, 231b, 231c, 231d, 231e, and 231f by using the control method described in the first embodiment or the second embodiment. As a result, the same effect as that of the first embodiment or the second embodiment can be obtained also in the AC-DC converter 2 illustrated in FIG. 24.

Note that although the switching elements 231a, 231b, 231c, 231d, 231e, and 231f are represented as IGBTs in FIG. 24, any elements may be used as long as switching operation can be performed. In addition, the AC-DC converter 2 illustrated in FIG. 24 is configured as a closed loop, but may be configured as an open loop. In a case where the AC-DC converter 2 is configured as an open loop, the detection values of the voltage detectors 227 and 217b and the current detectors 211a and 211b need not be used. Furthermore, the control according to the fourteenth embodiment may be performed on the α, β coordinates or on the three-phase coordinates.

### Fifteenth Embodiment

In a fifteenth embodiment, a description will be given of an example different from the above example of the AC-DC converter 2 including the controller 6 described in the first embodiment or the second embodiment. Note that components having the same or equivalent functions as the components of the AC-DC converter 2 described in the first and second embodiments are denoted by the same reference numerals, and redundant descriptions will be omitted.

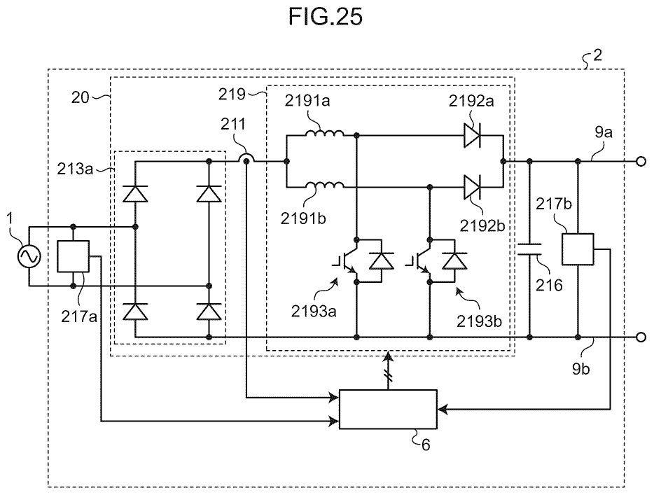

FIG. 25 is a diagram illustrating an exemplary configuration of the AC-DC converter 2 according to the fifteenth embodiment. In the AC-DC converter 2 of FIG. 25, the rectifier circuitry 20 includes the single-phase diode bridge cell 213a and an interleaved cell 219. The interleaved cell 219 includes two sets of the reactor 212, the switching element 215, and the diode 218 included in the configuration of the full PAM circuit described in FIG. 12. Specifically, the interleaved cell 219 includes reactors 2191a and 2191b, diodes 2192a and 2192b, and switching elements 2193a and 2193b. Note that the configuration and operation of the rectifier circuitry 20 illustrated in FIG. 25 are known, and further description thereof is omitted here.

The controller 6 generates switching signals for the two switching elements 2193a and 2193b and drives the two switching elements 2193a and 2193b by using the control method described in the first embodiment or the second embodiment. As a result, the same effect as that of the first embodiment or the second embodiment can be obtained also in the AC-DC converter 2 illustrated in FIG. 25.

Note that although the switching elements 2193a and 2193b are represented as IGBTs in FIG. 25, any elements may be used as long as switching operation can be performed. Furthermore, the AC-DC converter 2 illustrated in FIG. 25 is configured as a closed loop, but may be configured as an open loop. In a case where the AC-DC converter 2 is configured as an open loop, detection values of the voltage detectors 217a and 217b and the current detector 211 need not be used. In addition, although the interleaved cell 219 including two stages is exemplified in FIG. 25, the interleaved cell 219 may include three or more stages. Moreover, the rectifier circuitries 20 described in the first to fourteenth embodiments may also have an interleaved configuration.

### Sixteenth Embodiment

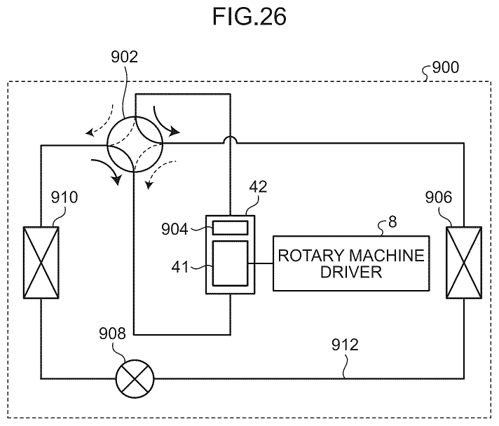

FIG. 26 is a diagram illustrating an exemplary configuration of a refrigeration cycle applied equipment 900 according to a sixteenth embodiment. The refrigeration cycle applied equipment 900 according to the sixteenth embodiment includes the rotary machine driver 8 described in the first embodiment. The refrigeration cycle applied equipment 900 according to the sixteenth embodiment can be applied to products having a refrigeration cycle, such as an air conditioner, a refrigerator, a freezer, and a heat pump water heater.

The refrigeration cycle applied equipment 900 includes: a compressor 42 including the motor 41 according to the first embodiment; a four-way valve 902; an indoor heat exchanger 906; an expansion valve 908; and an outdoor heat exchanger 910, which are installed via a refrigerant pipe 912. The compressor 42 includes the motor 41 in the first embodiment. Inside the compressor 42, a compression mechanism 904 that compresses a refrigerant, and the motor 41 that causes the compression mechanism 904 to operate are provided. The refrigeration cycle applied equipment 900 can perform heating operation or cooling operation according to switching operation of the four-way valve 902.

The compression mechanism 904 is driven by the motor 41 that is under variable speed control. During the heating operation, the refrigerant is pressurized by the compression mechanism 904 and delivered therefrom, passes through the four-way valve 902, the indoor heat exchanger 906, the expansion valve 908, the outdoor heat exchanger 910, and the four-way valve 902, and returns to the compression mechanism 904, as indicated by solid arrows. During the cooling operation, the refrigerant is pressurized by the compression mechanism 904 and delivered therefrom, passes through the four-way valve 902, the outdoor heat exchanger 910, the expansion valve 908, the indoor heat exchanger 906, and the four-way valve 902, and returns to the compression mechanism 904, as indicated by broken arrows. During the heating operation, the indoor heat exchanger 906 acts as a condenser to release heat, and the outdoor heat exchanger 910 acts as an evaporator to absorb heat. During the cooling operation, the outdoor heat exchanger 910 acts as a condenser to release heat, and the indoor heat exchanger 906 acts as an evaporator to absorb heat. The expansion valve 908 decompresses and expands the refrigerant.

Note that the refrigeration cycle applied equipment 900 according to the sixteenth embodiment has been described as including the rotary machine driver 8 described in the first embodiment, but is not limited thereto. The refrigeration cycle applied equipment 900 may include the rotary machine driver 8 including the rectifier circuitry 20 described in the second to fifteenth embodiments. Furthermore, as long as the control method of the first embodiment or the second embodiment can be applied, the refrigeration cycle applied equipment 900 may include the rotary machine driver 8 including a rectifier circuitry other than the rectifier circuitry 20 described in the first to fifteenth embodiments.

The configurations set forth in the above embodiments show examples, and it is possible to combine the configurations with another known technique or combine the embodiments with each other, and is also possible to partially omit or change the configurations without departing from the scope of the present disclosure. For example, the control method described above is also applicable to a DC-AC converter.

### REFERENCE SIGNS LIST

1 AC power supply; 2 AC-DC converter; 3 DC-AC converter; 4 load; 5 three-phase AC power supply; 6 controller; 7 current control system; 8 rotary machine driver; 9a, 9b DC bus; 20 rectifier circuitry; 41 motor; 42 compressor; 61 voltage controller; 62 current controller; 63 switching signal generator; 72 control device; 73 to-be-controlled plant; 74, 624 target value filter; 211, 211a, 211b current detector; 212, 212a, 212b, 212c, 2191a, 2191b reactor; 213a, 213b, 213c single-phase diode bridge cell; 215, 215a, 215b, 215c, 220a, 220b, 220c, 220d, 220e, 220f, 220g, 220h, 231a, 231b, 231c, 231d, 231e, 231f, 2193a, 2193b switching element; 216, 216a, 216b, 216c, 216d capacitor; 217a, 217b, 217c, 227 voltage detector; 218, 218a, 218b, 218c, 2192a, 2192b diode; 219 interleaved cell; 221 single-phase H bridge cell; 222, 225 switching cell; 226 three-phase full-bridge cell; 228 three-phase diode bridge cell; 229 three-phase simplified PAM cell; 231 three-phase bidirectional switching cell; 611 voltage control device; 612, 622 subtracter; 621 current control device; 623 multiplier; 900 refrigeration cycle applied equipment; 902 four-way valve; 904 compression mechanism; 906 indoor heat exchanger; 908 expansion valve; 910 outdoor heat exchanger; 912 refrigerant pipe.

1. An AC-DC converter comprising:
a rectifier circuitry, including at least one switching element, configured to rectify power supply voltage applied from an AC power supply;
a capacitor, connected to a DC bus, configured to smooth output voltage of the rectifier circuitry;
a reactor disposed closer to the AC power supply than the capacitor; and
a controller configured to generate a switching signal for controlling the switching element, wherein
the switching element is disposed closer to the AC power supply than the capacitor, wherein
the controller includes:
a voltage controller configured to generate a first current command value by using a first voltage command value being a command value of bus voltage that is voltage of the DC bus;
a current controller configured to generate a second voltage command value by using a second current command value obtained as a result of causing the first current command value to follow a sinusoidal wave; and
a switching signal generator configured to generate the switching signal such that a harmonic component included in power supply current flowing between the AC power supply and the rectifier circuitry conforms to a harmonic standard value of the power supply current by using the second voltage command value, wherein
the current controller includes a current control device constituted by a proportional sinusoidal control device, a proportional integral sinusoidal control device or a proportional integral resonant control device.

2. (canceled)

3. The AC-DC converter according to claim 1, comprising:
a current detector configured to detect the power supply current flowing between the AC power supply and the rectifier circuitry;
a first voltage detector configured to detect the bus voltage; and
a second voltage detector configured to detect the power supply voltage, wherein
the first current command value is generated using a voltage deviation that is a difference between the first voltage command value and a detection voltage detected by the first voltage detector,
the sinusoidal wave is generated based on a voltage phase detected by the second voltage detector, and
the second voltage command value is generated using a current deviation that is a difference between the second current command value and a detection current detected by the current detector.

4. The AC-DC converter according to claim 3, wherein
low-order harmonics are superimposed on the power supply current.

5. The AC-DC converter according to claim 3, wherein
a sum of harmonic components of the power supply current is 10% or more of a fundamental wave of the power supply current.

6. The AC-DC converter according to claim 3, wherein
the current controller includes a filter configured to manipulate a zero point of a feedback loop in which the second voltage command value output from the current controller is fed back to an input stage of the second current command value.

7. A rotary machine driver comprising the AC-DC converter according to claim 1.

8. A refrigeration cycle applied equipment comprising the AC-DC converter according to claim 1.

9. An AC-DC converter comprising:
a rectifier circuitry configured to rectify power supply voltage applied from an AC power supply, the rectifier circuitry including at least one switching element;
a capacitor configured to smooth output voltage of the rectifier circuitry, the capacitor being connected to a DC bus;
a reactor disposed closer to the AC power supply than the capacitor;
a controller configured to generate a switching signal for controlling the switching element;
a current detector configured to detect power supply current flowing between the AC power supply and the rectifier circuitry;
a first voltage detector configured to detect bus voltage that is voltage of the DC bus; and
a second voltage detector configured to detect the power supply voltage, wherein
the switching element is disposed closer to the AC power supply than the capacitor,
the controller includes:
a voltage controller configured to generate a first current command value by using a first voltage command value, the first voltage command value being a command value of the bus voltage;
a current controller configured to generate a second voltage command value by using a second current command value, the second current command value being obtained as a result of causing the first current command value to follow a sinusoidal wave; and
a switching signal generator configured to generate the switching signal by using the second voltage command value such that a harmonic component included in the power supply current conforms to a harmonic standard value of the power supply current, the power supply current flowing between the AC power supply and the rectifier circuitry,
the first current command value is generated by use of a voltage deviation that is a difference between the first voltage command value and a detection voltage, the detection voltage being detected by the first voltage detector,
the sinusoidal wave is generated based on a voltage phase detected by the second voltage detector, and
the second voltage command value is generated by use of a current deviation that is a difference between the second current command value and a detection current, the detection current being detected by the current detector.

10. The AC-DC converter according to claim 9, wherein
low-order harmonics are superimposed on the power supply current.

11. The AC-DC converter according to claim 9, wherein
a sum of harmonic components of the power supply current is 10% or more of a fundamental wave of the power supply current.

12. The AC-DC converter according to claim 9, wherein
the current controller includes a filter configured to manipulate a zero point of a feedback loop in which the second voltage command value output from the current controller is fed back to an input stage of the second current command value.

13. A rotary machine driver comprising the AC-DC converter according to claim 9.

14. A refrigeration cycle applied equipment comprising the AC-DC converter according to claim 9.
